(19) United States
(12) Patent Application Publication
(10) Pub. No.: US 2017/0235473 A1
(43) Pub. Date: Aug. 17, 2017

(54) Method and Apparatus for Loading Application Program View, and Electronic Terminal

(71) Applicant: Huawei Technologies Co., Ltd., Shezhen (CN)

(72) Inventors: Bingtian Han, Shenzhen (CN); Lei Qi, Shenzhen (CN); Yao Wang, Santa Clara, CA (US)

(73) Assignee: Huawei Technologies, Co., Ltd., Shenzhen (CN)

(21) Appl. No.: 15/503,112

(22) PCT Filed: Aug. 11, 2014
(86) PCT No.: PCT/CN2014/084115

§ 371 Date: Feb. 10, 2017

(51) Int. Cl. G06F 3/0484

(52) U.S. Cl. CPC G06F 3/04847; G06F 2203/04803

(57) ABSTRACT

Apparatus and method for loading an application program view including obtaining view information of an application program, where the view information includes layout manner information of a view element, in a display interface, of an application program view, dimension information of the view element, and coordinate information of the view element in the display interface, performing serialization processing on the view information to obtain a byte stream used to display the application program view, and saving the byte stream in a non-volatile storage medium, so as to load the application program view according to the saved byte stream when the application program view is reloaded.

This application is a national stage of International Application No. PCT/CN2014/084115, filed on Aug. 11, 2014, which is hereby incorporated by reference in its entirety.

### TECHNICAL FIELD

The present disclosure relates to the field of electronic information technologies, and in particular, to a method and an apparatus for loading an application program view, and an electronic terminal.

### BACKGROUND

As mobile communications technologies develop, an electronic terminal becomes more intelligent. Various application programs that can provide different services for a user may run on the electronic terminal. The electronic terminal may display, by using a display interface (display screen), an application program view (that is, a user interface) of an application program running on the electronic terminal. The application program view mainly includes view elements such as a ViewGroup and a view object. One ViewGroup may include multiple view objects, or one ViewGroup may be nested in another ViewGroup. The view object may include a text box, a button, and the like. The electronic terminal includes a mobile phone, a tablet computer, a personal computer, and the like.

In the prior art, when running an application program and loading an application program view, an electronic terminal needs to calculate related view information of the application program one by one, for example, coordinates of a view element, and then presents the application program view in a display interface of the electronic terminal according to the related view information, obtained by means of calculation, of the application program. After a user turns off the electronic terminal or a user exits from the application program, when running the application program again, the electronic terminal needs to recalculate the related view information of the application program to generate the application program view. Therefore, time for starting the application program is relatively long, startup efficiency is relative low, and user experience is poor.

### SUMMARY

Embodiments of the present disclosure provide a method and an apparatus for loading an application program view, and an electronic terminal, to resolve a problem in the prior art that time used to load the application program view each time is relatively long.

According to a first aspect of the embodiments of the present disclosure, a method for loading an application program view is provided, including obtaining view information of an application program, where the view information includes layout manner information of a view element, in a display interface, of an application program view, dimension information of the view element, and coordinate information of the view element in the display interface; performing serialization processing on the view information to obtain a byte stream used to display the application program view; and saving the byte stream in a non-volatile storage medium, so as to load the application program view according to the saved byte stream when the application program view is reloaded.

With reference to the first aspect, in a first possible implementation manner, the method for loading an application program view further includes, when the application program view is loaded, if it is determined that the non-volatile storage medium stores the byte stream used to display the view, reading the byte stream from the non-volatile storage medium; performing deserialization processing on the byte stream to obtain the view information; and displaying the application program view in the display interface according to the view information.

With reference to the first aspect or the first possible implementation manner of the first aspect, in a second possible implementation manner, the performing serialization processing on the view information to obtain a byte stream used to display the view includes allocating an identifier to the view element, and recording a correspondence between the view element and the identifier of the view element; and performing serialization processing on the layout manner information of the view element in the display interface, the dimension information of the view element, and the coordinate information of the view element in the display interface according to the identifier allocated to the view element, to obtain the byte stream used to display the application program view.

With reference to the first aspect, or the first possible implementation manner or the second possible implementation manner of the first aspect, in a third possible implementation manner, the obtaining view information of an application program includes parsing a layout file in an installation package of the application program to obtain the layout manner information of the view element in the display interface; and obtaining, by means of calculation, the dimension information of the view element and the coordinate information of the view element in the display interface according to the layout manner information.

With reference to the first aspect, or the first possible implementation manner or the second possible implementation manner of the first aspect, in a fourth possible implementation manner, the saving the byte stream in a non-volatile storage medium includes saving the byte stream in a predefined file, where the predefined file includes a data file of the application program, and the data file of the application program is saved in the non-volatile storage medium and is used to store data information to be invoked by the application program.

According to a second aspect of the embodiments of the present disclosure, a computer storage medium is provided, where the computer storage medium stores program code, and when the program code is executed, steps as described in any of the embodiments are included; and the computer storage medium includes a non-volatile storage medium.

According to a third aspect of the embodiments of the present disclosure, an apparatus for loading an application program view is provided, including a obtaining unit, configured to obtain view information of an application program, where the view information includes layout manner information of a view element, in a display interface, of an application program view, dimension information of the view element, and coordinate information of the view element in the display interface; a serialization unit, configured to perform serialization processing on the view information obtained by the obtaining unit, to obtain a byte stream used to display the application program view; and a processing unit, configured to save, in a non-volatile storage medium, the byte stream obtained by the serialization unit, so as to load the application program view according to the saved byte stream when the application program view is reloaded.

With reference to the third aspect, in a first possible implementation manner, the apparatus for loading an application program view further includes a reading unit, configured to, when the application program view is loaded, if it is determined that the non-volatile storage medium stores the byte stream used to display the view, read the byte stream from the non-volatile storage medium; a deserialization unit, configured to perform deserialization processing on the byte stream read by the reading unit, to obtain the view information; and a display unit, configured to display the application program view in the display interface according to the view information obtained by the deserialization unit.

With reference to the third aspect or the first possible implementation manner of the third aspect, in a second possible implementation manner, the serialization unit includes an allocation subunit, configured to allocate an identifier to the view element, and record a correspondence between the view element and the identifier of the view element; and a serialization subunit, configured to perform serialization processing on the layout manner information of the view element in the display interface, the dimension information of the view element, and the coordinate information of the view element in the display interface according to the identifier allocated by the allocation subunit to the view element, to obtain the byte stream used to display the application program view.

With reference to the third aspect, or the first possible implementation manner or the second possible implementation manner of the third aspect, in a third possible implementation manner, the obtaining unit includes a parsing subunit, configured to parse a layout file in an installation package of the application program to obtain the layout manner information of the view element in the display interface; and a calculation subunit, configured to obtain, by means of calculation, the dimension information of the view element and the coordinate information of the view element in the display interface according to the layout manner information obtained by the parsing subunit by means of parsing.

With reference to the third aspect, or the first possible implementation manner or the second possible implementation manner of the third aspect, in a fourth possible implementation manner, the processing unit is specifically configured to save, in a predefined file, the byte stream obtained by the serialization unit, where the predefined file includes a data file of the application program, and the data file of the application program is saved in the non-volatile storage medium and is used to store data information to be invoked by the application program.

According to a fourth aspect of the embodiments of the present disclosure, an electronic terminal is provided, where the electronic terminal includes a memory and a processor, and the memory is connected to the processor; the memory is configured to store a group of program code, the memory is a computer storage medium of the electronic terminal, and the computer storage medium includes a non-volatile storage medium; the processor is configured to execute the program code saved in the memory and is specifically configured to perform the following operations: obtaining view information of an application program, where the view information includes layout manner information of a view element, in a display interface, of an application program view, dimension information of the view element, and coordinate information of the view element in the display interface; performing serialization processing on the view information to obtain a byte stream used to display the application program view; and saving the byte stream in the non-volatile storage medium, so as to load the application program view according to the saved byte stream when the application program view is reloaded; and the non-volatile storage medium is configured to store the byte stream that is obtained by the processor by means of serialization processing and used to display the application program view.

With reference to the fourth aspect, in a first possible implementation manner, the processor is further configured to when the application program view is loaded, if it is determined that the non-volatile storage medium stores the byte stream used to display the view, read the byte stream from the non-volatile storage medium; and perform deserialization processing on the byte stream to obtain the view information, and display the application program view in the display interface according to the view information.

With reference to the fourth aspect or the first possible implementation manner of the fourth aspect, in a second possible implementation manner, the processor is further configured to allocate an identifier to the view element, and record a correspondence between the view element and the identifier of the view element; and perform serialization processing on the layout manner information of the view element in the display interface, the dimension information of the view element, and the coordinate information of the view element in the display interface according to the identifier allocated to the view element, to obtain the byte stream used to display the application program view.

With reference to the fourth aspect, or the first possible implementation manner or the second possible implementation manner of the fourth aspect, in a third possible implementation manner, the processor is further configured to parse a layout file in an installation package of the application program to obtain the layout manner information of the view element in the display interface; and obtain, by means of calculation, the dimension information of the view element and the coordinate information of the view element in the display interface according to the layout manner information.

With reference to the fourth aspect, or the first possible implementation manner or the second possible implementation manner of the fourth aspect, in a fourth possible implementation manner, the processor is further configured to save the byte stream in a predefined file, where the predefined file includes a data file of the application program, and the data file of the application program is used to store data information to be invoked by the application program; and the non-volatile storage medium is further configured to store the data file of the application program.

According to the method and the apparatus for loading an application program view, and the electronic terminal that are provided in the embodiments of the present disclosure, after view information used to load an application program view is obtained, serialization processing can be performed on the view information to obtain a byte stream used to display the application program view; and the byte stream is saved in a non-volatile storage medium. The non-volatile storage medium of the electronic terminal stores the byte stream used to display the application program view; therefore, the electronic terminal does not need to parse a layout file and calculate dimension information and coordinate information of a view element each time of loading the application program view, but can directly load the application program according to the byte stream that is saved in the non-volatile storage medium and used to display the application program view, which can reduce time used to load the application program view. Because the time used to load the application program view is shortened, startup efficiency of the application program is improved, and user experience can be improved.

### BRIEF DESCRIPTION OF DRAWINGS

To describe the technical solutions in the embodiments of the present disclosure or in the prior art more clearly, the following briefly describes the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a flowchart of a method for loading an application program view according to an embodiment of the present disclosure;

FIG. 2 is schematic diagram of a view element according to an embodiment of the present disclosure;

FIG. 3A and FIG. 3B are a flowchart of another method for loading an application program view according to an embodiment of the present disclosure;

FIG. 4 is a schematic diagram of an application program view of an Android® system according to an embodiment of the present disclosure;

FIG. 5 is schematic diagram of a byte stream format according to an embodiment of the present disclosure;

FIG. 6 is a flowchart of another method for loading an application program view according to an embodiment of the present disclosure;

FIG. 7 is a flowchart of another method for loading an application program view according to an embodiment of the present disclosure;

FIG. 8 is a schematic composition diagram of an apparatus for loading an application program view according to an embodiment of the present disclosure;

FIG. 9 is a schematic composition diagram of another apparatus for loading an application program view according to an embodiment of the present disclosure;

FIG. 10 is a schematic composition diagram of another apparatus for loading an application program view according to an embodiment of the present disclosure;

FIG. 11 is a schematic composition diagram of another apparatus for loading an application program view according to an embodiment of the present disclosure;

FIG. 12 is a schematic composition diagram of an electronic terminal according to an embodiment of the present disclosure; and

FIG. 13 is a schematic composition diagram of another electronic terminal according to an embodiment of the present disclosure.

### DESCRIPTION OF EMBODIMENTS

The following clearly and completely describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

In the embodiments of the present disclosure, a process of loading an application program view by an electronic terminal may be applied to at least following two situations: One is a process of loading an application program view when the electronic terminal starts an application program for the first time after the electronic terminal is turned on; the other is a process of loading an application program view when the electronic terminal remains in a turned-on state and restarts an application program after the electronic terminal exits from running of the application program.

### Embodiment 1

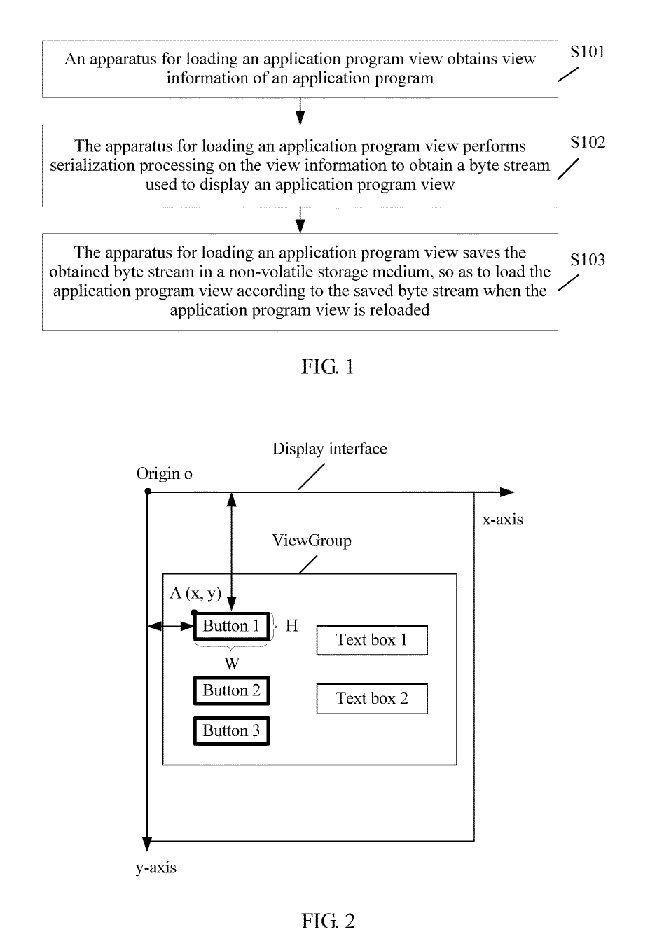

This embodiment of the present disclosure provides a method for loading an application program view, where the method may be applied to an electronic terminal with a display interface and a non-volatile storage medium. As shown in FIG. 1, the method includes the following steps.

S101. An apparatus for loading an application program view obtains view information of an application program.

The view information includes layout manner information of a view element, in a display interface, of an application program view, dimension information of the view element, and coordinate information of the view element in the display interface.

Specifically, the apparatus for loading an application program view may obtain the layout manner information of the view element in the display interface by parsing a layout file in an installation package of the application program, and obtain, by means of calculation, the dimension information of the view element and the coordinate information of the view element in the display interface according to the layout manner information.

Generally, the layout file is in an Extensible Markup Language (XML) format, and the layout file is included in the Android installation package (APK) of the application program. A control apparatus for loading a view may parse the layout file of the application program view by using a parser. Commonly used parsers include a simple application programming interface for Extensible Markup Language (SAX) parser, a document object model (DOM) parser, a Pull parser built in an Android system, and the like.

The view element includes a ViewGroup and a view object. The view object may include a text box, an edit box, a button, a check box, and the like. The ViewGroup is used to bear the view object, and the ViewGroup and a view constitute the application program view. One ViewGroup may include multiple view objects, or one ViewGroup may be nested in another ViewGroup.

The layout manner information of the view element in the display interface may be used to indicate a relative location relationship between a ViewGroup and a view object, a relative location relationship and a nesting relationship between a ViewGroup and a ViewGroup, a relative location relationship between a view object and a view object, and indicate that dimension information of a view object depends on content of the view object, and the like.

The dimension information of the view element may be represented by using a width of the view element and a height of the view element; the coordinate information of the view element in the display interface may be represented by using left (a distance from a left margin of the view element to a left margin of the display interface) and top (a distance from a top of the view element to a top of the display interface) parameters.

As shown in FIG. 2, the display interface includes one ViewGroup and five view objects, where the ViewGroup may be abstracted as a rectangular box. The five view objects are three buttons (a button 1, a button 2, and a button 3) and two text boxes (a text box 1 and a text box 2). The layout manner information of the view element in the display interface may be used to indicate relative location relationships between the ViewGroup and the five view objects, or may be used to indicate relative location relationships between the five view objects, or the like. A coordinate system in which a point in an upper left corner of the display interface is used as an origin, a rightward direction of an x-axis is an increasing direction, and a downward direction of a y-axis is an increasing direction may be created. The button 1 is used as an example for description. Coordinate information of the button 1 in the display interface may be represented by using coordinates (x, y) of a point A in an upper left corner of the button 1, that is, left=x, and top=y. Dimension information of the button 1 may be represented by using a width W of the button 1 and a height H of the button 1.

It should be noted that, in this embodiment of the present disclosure, the apparatus for loading an application program view may be an electronic terminal or a processor in an electronic terminal. The electronic terminal may be any electronic device such as a mobile phone, a tablet computer, or a personal computer. The processor may be a central processing unit (CPU) of the electronic terminal. Specific content of the control apparatus for loading a view is not limited in this embodiment of the present disclosure.

S102. The apparatus for loading an application program view performs serialization processing on the view information to obtain a byte stream used to display an application program view.

A process of the serialization processing may include allocating, by the apparatus for loading an application program view, an identifier to the view element, and recording a correspondence between the view element and the identifier of the view element; and performing, by the apparatus for loading an application program view, serialization processing on the layout manner information of the view element in the display interface, the dimension information of the view element, and the coordinate information of the view element in the display interface according to the identifier allocated to the view element, to obtain the byte stream used to display the application program view.

Exemplarily, the serialization processing may be a process of converting a to-be-processed object (for example, the view information in this embodiment of the present disclosure) into a binary sequence. The identifier of the view element, the layout manner information of the view element in the display interface, the dimension information of the view element, and the coordinate information of the view element in the display interface are all converted into binary sequences and saved as the byte stream by bytes, where each byte is an 8-bit binary number.

Specifically, the apparatus for loading an application program view may predefine a byte stream format, and performs serialization processing on the view information according to the predefined byte stream format.

For example, the predefined byte stream format may be that an identifier of each view element is followed closely by view information of the view element, where both the identifier of the view element and the view information of the view element are binary numbers. For a specific format, reference may be made to a related description in Embodiment 2.

It should be noted that, in this embodiment of the present disclosure, a process of the serialization processing includes but is not limited to the process of the serialization processing described in the foregoing embodiment. For another implementation method of the serialization processing, reference may be made to a related description in the prior art, which is not listed one by one in this embodiment of the present disclosure.

S103. The apparatus for loading an application program view saves the obtained byte stream in a non-volatile storage medium, so as to load the application program view according to the saved byte stream when the application program view is reloaded.

The application program view includes the view element. The apparatus for loading an application program view may save the obtained byte stream in a predefined file, where the predefined file includes a data file of the application program, and the data file of the application program is saved in the non-volatile storage medium. Certainly, the apparatus for loading an application program view may save the obtained byte stream in a newly generated file, where the newly generated file is saved in the non-volatile storage medium. The non-volatile storage medium may be an embedded multimedia card (EMMC). The EMMC includes an embedded storage solution, which is provided with a multimedia card (MMC) interface, a flash memory, and a main controller. At present, the EMMC is a local storage solution most widely applied to the electronic terminal.

It should be noted that, when loading the application program view at a next time, the electronic terminal may directly read the saved byte stream from the non-volatile storage medium and perform deserialization processing on the byte stream, to display, in the display interface, the application program view that includes the view element. The display interface may be a display screen of the electronic terminal.

The deserialization is a process of restoring a binary sequence to an original object (for example, the view information in this embodiment of the present disclosure). Data is saved in a memory in a binary form, the byte stream is also saved in a binary form, and when the application program view is loaded, data needs to be read into the memory. Therefore, time used to load the application program view according to the saved byte stream is shorter than that used to load the application program view according to a file in another format (for example, a text file and a table file).

According to the method for loading an application program view provided in this embodiment of the present disclosure, after view information used to load an application program view is obtained, serialization processing can be performed on the view information to obtain a byte stream used to display the application program view; and the byte stream is saved in a non-volatile storage medium. The non-volatile storage medium of an electronic terminal stores the byte stream used to display the application program view; therefore, the electronic terminal does not need to parse a layout file and calculate dimension information and coordinate information of a view element each time of loading the application program view, but can directly load the application program according to the byte stream that is saved in the non-volatile storage medium and used to display the application program view, which can reduce time used to load the application program view. Because the time used to load the application program view is shortened, startup efficiency of the application program is improved, and user experience can be improved.

### Embodiment 2

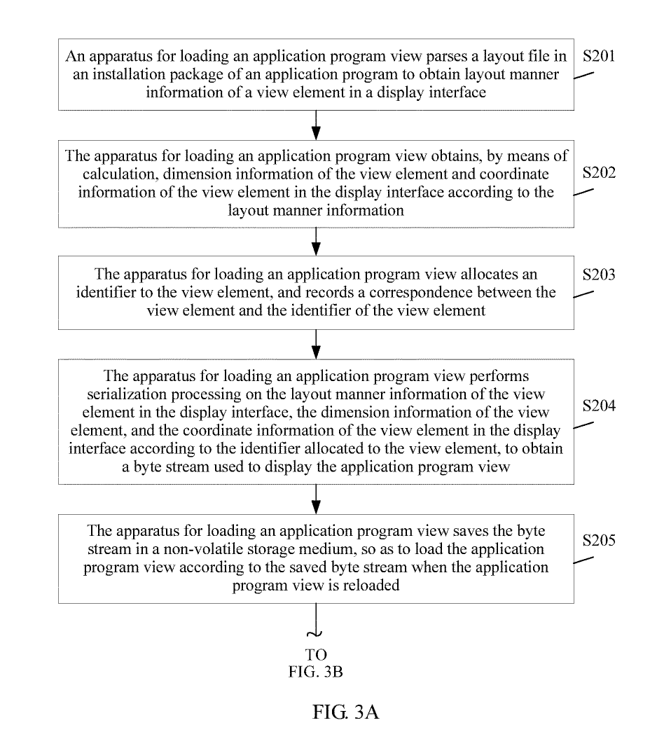

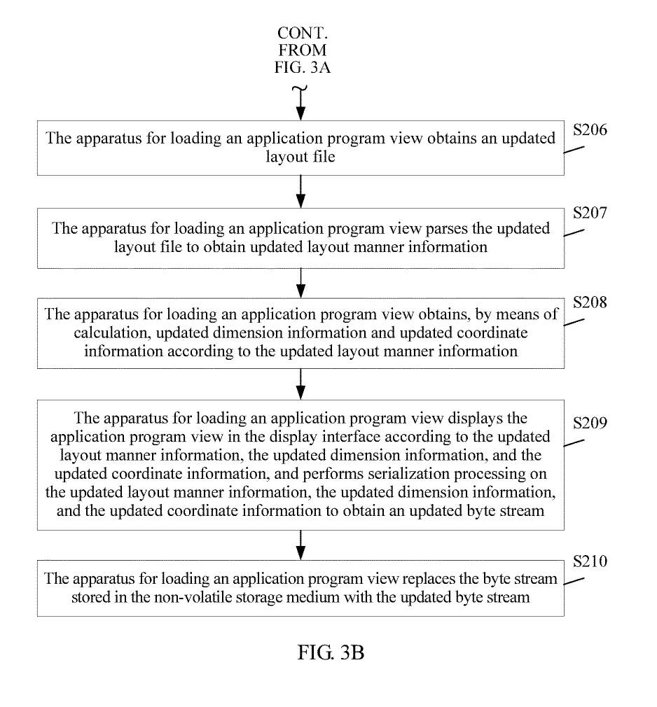

This embodiment of the present disclosure provides a method for loading an application program view. As shown in FIG. 3A and FIG. 3B, the method includes the following steps.

S201. An apparatus for loading an application program view parses a layout file in an installation package of an application program to obtain layout manner information of a view element in a display interface.

Generally, the layout file is in an XML format, and the layout file is included in the installation package of the application program. A control apparatus for loading a view may parse the layout file of an application program view by using a parser. Commonly used parsers include a SAX parser, a DOM parser, a Pull parser built in an Android system, and the like.

The view element includes a ViewGroup and a view object. The view object may include a text box, an edit box, a button, a check box, and the like. The ViewGroup is used to bear the view object, and the ViewGroup and a view constitute the application program view. One ViewGroup may include multiple view objects, or one ViewGroup may be nested in another ViewGroup.

Exemplarily, the layout manner information of the view element in the display interface may be used to indicate a relative location relationship between a ViewGroup and a view object (for example, a distance from a left margin of the view object to a left margin of the ViewGroup, a distance from a top of the view object to a top of the ViewGroup, or the view object is located in a center of the ViewGroup), a relative location relationship and a nesting relationship between a ViewGroup and a ViewGroup (for example, a distance from a left margin of a ViewGroup 1 to a left margin of a ViewGroup 2, a distance from a top of a ViewGroup 1 to a top of a ViewGroup 2, or a ViewGroup 1 is located in a center of a ViewGroup 2), a relative location relationship between a view object and a view object (for example, a distance from a left margin of a view object 1 to a left margin of a view object 2, a distance from a top of a view object 1 to a top of a view object 2, or a view object 2 is located in a center of a view object 1), and indicate that dimension information of a view object depends on content of the view object, and the like.

S202. The apparatus for loading an application program view obtains, by means of calculation, dimension information of the view element and coordinate information of the view element in the display interface according to the layout manner information.

The dimension information of the view element may be represented by using a width of the view element and a height of the view element.

For example, when the relative location relationship between the ViewGroup and the view object is that margins of the ViewGroup coincide with margins of the display interface, it can be calculated that a width of the ViewGroup is equal to a width of the display interface and a height of the ViewGroup is equal to a height of the display interface.

When the relative location relationship between the ViewGroup and the view object is that the ViewGroup is located in a center of the display interface and dimensions of the ViewGroup are in proportion to dimensions of the display interface, the dimensions of the ViewGroup may be calculated according to the dimensions of the display interface. It is assumed that the width of the ViewGroup and the width of the display interface, and the height of the ViewGroup and the height of the display interface all meet a linear function y=kx+b, where k is a proportional coefficient, and b is a constant. When x1 is the width of the display interface, y1=kx1+b is the width of the ViewGroup. When x2 is the height of the display interface, y2=kx2+b is the height of the ViewGroup.

When the relative location relationship between the ViewGroup and the view object is that the ViewGroup is located in a center of the display interface, a width of the ViewGroup is W1, a height of the ViewGroup is H1, a distance from a left margin of the view object to that of the ViewGroup is S1, and a distance from a top of the view object to that of the ViewGroup is S2, it may be calculated that a width of the view object is (W1−2×S1) and a height of the view object is (H1−2×S2).

Similar to the foregoing description, dimensions of the view object may be obtained by means of calculation according to dimension information of the display interface and the layout manner information of the view element in the display interface. Certainly, when the dimension information of the view element depends on content of the view element, the dimension information of the view element may be obtained according to the content of the view element.

It should be noted that the foregoing description provides only some simple examples for calculating the dimension information of the view element. There may be multiple situations of the layout manner information of the view element in the display interface, and accordingly, there are multiple methods for calculating the dimension information of the view element, which are not listed one by one in this embodiment of the present disclosure.

The coordinate information of the view element in the display interface may be represented by using left (a distance from a left margin of the view element to a left margin of the display interface) and top (a distance from a top of the view element to a top of the display interface) parameters, and may be represented as (left, top).

For example, when the layout manner information of the view element in the display interface indicates that a distance from the left margin of the ViewGroup to the left margin of the display interface is A1, a distance from the top of the ViewGroup to the top of the display interface is A2, a distance from a left margin of a view object 1 to the left margin of the ViewGroup is B1, and a distance from a top of the view object 1 to the top of the ViewGroup is B2, it may be calculated that coordinate information of the view object 1 in the display interface is (A1+B1, A2+B2).

When the layout manner information of the view element in the display interface indicates that dimension information of a view object 1 is (width W1, height H1), a height of a view object 2 is the same as that of the view object 1, a bottom of the view object 2 is aligned with that of the view object 1, the view object 2 is on the right of the view object 1, and a distance from a left margin of the view object 2 to a right margin of the view object 1 is C1, it may be calculated that coordinate information of the view object 2 in the display interface is (A1+B1+W1+C1, A2+B2).

It should be noted that the foregoing description provides only some simple examples for calculating the coordinate information of the view element in the display interface. There may be multiple situations of the layout manner information of the view element in the display interface, and accordingly, there are multiple methods for calculating the coordinate information of the view element in the display interface, which are not listed one by one in this embodiment of the present disclosure.

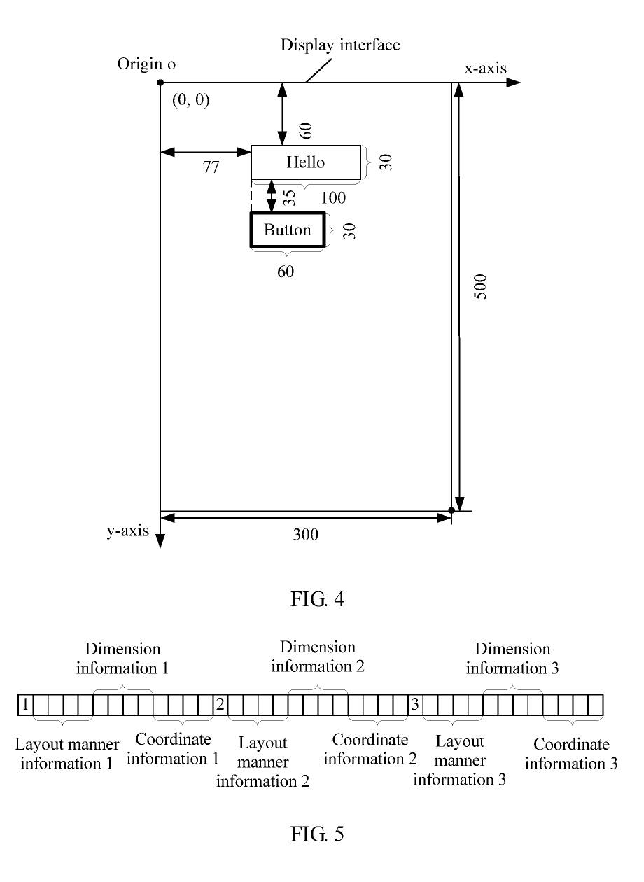

This embodiment of the present disclosure is described by using a simple view of an application program in an Android system as an example, where the view is shown in FIG. 4. A layout file corresponding to the view is as follows:

<RelativeLayout

xmlns:android=http://schemas.android.com/apk/res/android

<!—Declaration of Android namespace: a layout of the whole view is defined in a RelativeLayout tag, and a layout manner of the view is relative layout—>

xmlns:tools=http://schemas.android.com/tools <!—Indicate that a rule abided by for writing an xml file is subject to Android—>

android:layout_width=“match_parent” <!—Indicate a width of a ViewGroup in the relative layout—>

android:layout_height=“match_parent” <!—Indicate a height of the ViewGroup in the relative layout, where match_parent indicates that the height is the same as that of a parent—>

android:paddingBottom=“@dimen/activity_vertical_margin” <!—android:paddingBottom indicates a distance from a bottom of the ViewGroup in the relative layout to that of an Activity—>

android:paddingLeft=“@dimen/activity_horizontal_margin” <!—android:paddingLeft indicates a distance from a left margin of the ViewGroup in the relative layout to that of the Activity—>

android:paddingRight=“@dimen/activity_horizontal_margin” <!—android:paddingRight indicates a distance from a right margin of the ViewGroup in the relative layout to that of the Activity—>

android:paddingTop=“@dimen/activity_vertical_margin” <!—android:paddingTop indicates a distance from a top of the ViewGroup in the relative layout to that of the Activity—>

tools: context=“.MainActivity”>

<!—This statement is used to describe an activity corresponding to the current layout file when the application program is being developed—>

<!—The foregoing content indicates that the ViewGroup in linear layout covers the whole activity, that is, full-screen display—>

<TextView

<!—A TextView tag is a subtag of the RelativeLayout tag, where the tag defines a view object (a text box)—>

android:id=“@+id/textView1” <!—This statement defines that a unique identifier of the text box is textView1—>

android:layout_width=“wrap_content” <!—This statement indicates that a width of the text box varies with content of the text box—>

android:layout_height=“wrap_content” <!—This statement indicates that a height of the text box varies with the content of the text box—>

android:layout_alignParentLeft=“true” <!—This statement indicates that a left margin of the text box coincides with the left margin of the ViewGroup—>

android:layout_alignParentTop=“true” <!—This statement indicates that a top of the text box coincides with the top of the ViewGroup—>

android:layout_marginLeft=“77dp” <!—This statement indicates a distance from the left margin of the text box to the left margin of the ViewGroup—>

android:layout_marginTop=“60dp” <!—This statement indicates a distance from the top of the text box to the top of the ViewGroup—>

android:text=“Hello<!—This statement indicates that content displayed in the text box is “Hello”—>

<Button

<!—A Button tag is a subtag of the RelativeLayout tag, where the tag defines a view object (a button)—>

android:id=“@+id/button1” <!—This statement defines that a unique identifier of the button is button1—>

android:layout_width=“wrap_content” <!—This statement indicates that a width of the button varies with content of the button—>

android:layout_height=“wrap_content” <!—This statement indicates that a height of the button varies with the content of the button—>

android:layout_alignLeft=“@+id/textView1” <!—This statement indicates that a left margin of the button is aligned with the left margin of the text box—>

android:layout_below=“@+id/textView1” <!—This statement indicates that the button is below the text box—>

android:layout_marginTop=“35dp” <!—This statement indicates a distance from a top of the button to a bottom margin of the text box—>

android:text=“button”/> <!—This statement indicates that content displayed in the button is “button”—>

</RelativeLayout>, where

dp (device independent pixels, device independent pixels) is a unit of length related to resolution of the display interface (a display screen) of the electronic terminal and indicates a quantity of pixels.

In the application program in the Android system, the Activity is mainly responsible for creating a display window. Generally, an Activity represents an independent screen and is the only thing that can be seen by a user. Therefore, almost all Activities are used for interaction with the user. In specific implementation, each Activity is defined as an independent class. In an Activity class, a setContentView (View) method is used to display a user interface including a ViewGroup and a view object and to respond to events triggered by the user by using these view objects.

As shown in FIG. 4, a ViewGroup of the application program view includes two view objects, a text box and a button. Dimensions of the ViewGroup are the same as dimensions of the display interface. If the dimensions of the display interface are 300×500, a width of the ViewGroup is 300 and a height is 500. Coordinates of the ViewGroup in the display interface are (0, 0). It is assumed that a size of the text box is 100×30 (that is, a width of the text box is 100, and a height is 30), a size of the button is 60×30 (that is, a width of the button is 60, and a height is 30). A distance from a left margin of the text box to a left margin of the ViewGroup is 77, and a distance from a top of the text box to a top of the ViewGroup is 60; therefore, coordinates of the text box in the display interface are (77, 60). A left margin of the button is aligned with the left margin of the text box, a distance from a top of the button to a bottom margin of the text box is 35, and the height of the text box is 30; therefore, coordinates of the button in the display interface are (77, 125).

S203. The apparatus for loading an application program view allocates an identifier to the view element, and records a correspondence between the view element and the identifier of the view element.

The identifier allocated to the view element by the apparatus for loading an application program view may be a serial number or other identification (ID). Specific content of the identifier allocated to the view element by the apparatus for loading an application program view is not limited in this embodiment of the present disclosure. The correspondence between the view element and the identifier of the view element may be recorded in a manner of a table or a list. Certainly, the correspondence may also be recorded in another manner.

Exemplarily, the view in FIG. 4 is used as an example. The view includes only one ViewGroup, where the ViewGroup includes one text box and one button. A correspondence between the ViewGroup and an identifier of the ViewGroup and a correspondence between a view object and an identifier of the view object may be recorded in Table 1.

TABLE 1

| Identifier | View Element |
|---|---|
| 1 | ViewGroup |
| 2 | Text box |
| 3 | Button |

S204. The apparatus for loading an application program view performs serialization processing on the layout manner information of the view element in the display interface, the dimension information of the view element, and the coordinate information of the view element in the display interface according to the identifier allocated to the view element, to obtain a byte stream used to display the application program view.

Specifically, the apparatus for loading an application program view may perform serialization processing on the layout manner information, the dimension information, and the coordinate information of the view element by using a serialization manager, to obtain the byte stream. The serialization manager may be used to serialize and deserialize the byte stream. The serialization processing is a process of converting a to-be-processed object (for example, the view information in this embodiment of the present disclosure) into a binary sequence.

Exemplarily, the view in FIG. 4 is used as an example. Content on which the serialization processing needs to be performed includes layout manner information 1, dimension information 1, and coordinate information 1 of the ViewGroup; layout manner information 2, dimension information 2, and coordinate information 2 of the text box; and a layout manner 3, dimension information 3, and coordinate information 3 of the button. It should be noted that Table 2 is only an example of the content on which serialization processing needs to be performed, and the content on which serialization processing needs to be performed may not be limited to content shown in Table 2.

TABLE 2

| | |
|---|---|
| ViewGroup | Layout manner information 1 |
| | Dimension information 1 |
| | Coordinate information 1 |
| Text box | Layout manner information 2 |
| | Dimension information 2 |
| | Coordinate information 2 |
| Button | Layout manner information 3 |
| | Dimension information 3 |
| | Coordinate information 3 |

The apparatus for loading an application program view may predefine a byte stream format and then perform serialization processing on the layout manner information, the dimension information, and the coordinate information of the view element according to the predefined byte stream format, to obtain the byte stream.

For example, the predefined byte stream format may be that an identifier of each view element is followed closely by view information of the view element, where both the identifier of the view element and the view information of the view element are binary numbers. As shown in FIG. 5, a byte stream format corresponding to view information listed in Table 2 is provided. An identifier allocated to the ViewGroup by the apparatus for loading an application program view is 1, an identifier allocated to the text box is 2, and an identifier allocated to the button is 3. When the apparatus for loading an application program view performs serialization processing according to the format shown in FIG. 5, information in the byte stream is successively the identifier of the ViewGroup, the layout manner information 1, the dimension information 1, the coordinate information 1, the identifier of the text box, the layout manner information 2, the dimension information 2, the coordinate information 2, the identifier of the button, the layout manner information 3, the dimension information 3, and the coordinate information 3. FIG. 5 is only a schematic diagram of the byte stream format and does not indicate an actual quantity of bits of the byte stream. In an actual byte stream, the identifier of the ViewGroup, the layout manner information 1, the dimension information 1, the coordinate information 1, the identifier of the text box, the layout manner information 2, the dimension information 2, the coordinate information 2, the identifier of the button, the layout manner information 3, the dimension information 3, and the coordinate information 3 are all represented by using binaries.

S205. The apparatus for loading an application program view saves the byte stream in a non-volatile storage medium, so as to load the application program view according to the saved byte stream when the application program view is reloaded.

Saving, by the apparatus for loading an application program view, the byte stream in the non-volatile storage medium includes saving, by the apparatus for loading an application program view, the byte stream in a predefined file, where the predefined file includes a data file of the application program, and the data file of the application program is saved in the non-volatile storage medium and is used to store data information to be invoked by the application program.

The non-volatile storage medium may be an EMMC. At present, the EMMC is a local storage solution most widely applied to the electronic terminal. Certainly, the non-volatile storage medium may be another medium used to store the byte stream. Content of the non-volatile storage medium is not limited in this embodiment of the present disclosure.

It should be noted that when a version of the application program changes (for example, the application program is updated), which causes a change in the application program view, the apparatus for loading an application program view needs to update the saved byte stream. Specifically, a process of updating the saved byte stream includes S206 to S210.

S206. The apparatus for loading an application program view obtains an updated layout file.

The updated layout file is a layout file of an application program view of a new version obtained after the version of the application program changes. The updated layout file is included in an Android installation package (APK) of an application program of the new version.

S207. The apparatus for loading an application program view parses the updated layout file to obtain updated layout manner information.

S208. The apparatus for loading an application program view obtains, by means of calculation, updated dimension information and updated coordinate information according to the updated layout manner information.

S209. The apparatus for loading an application program view displays the application program view in the display interface according to the updated layout manner information, the updated dimension information, and the updated coordinate information, and performs serialization processing on the updated layout manner information, the updated dimension information, and the updated coordinate information to obtain an updated byte stream.

S210. The apparatus for loading an application program view replaces the byte stream saved in the non-volatile storage medium with the updated byte stream.

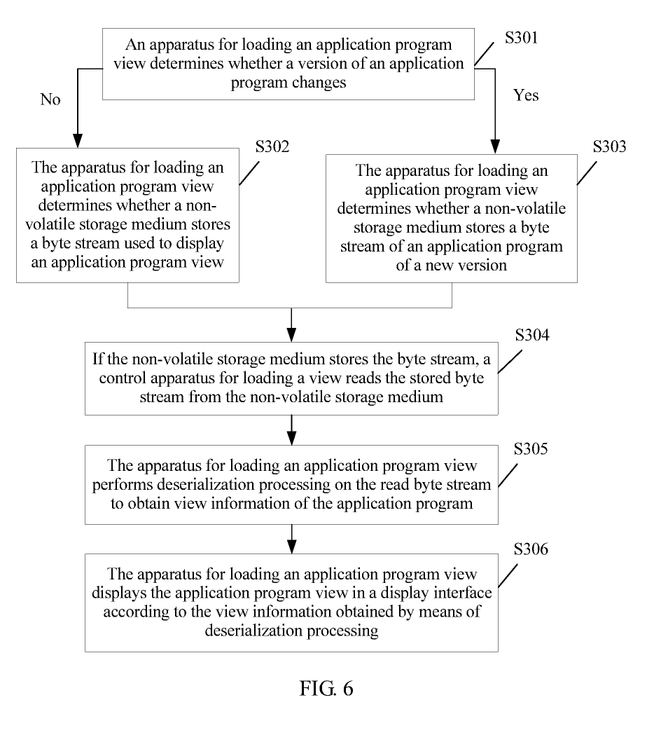

It should be noted that S201 to S210 are a process of saving the layout manner information, the dimension information, and the coordinate information by the apparatus for loading an application program view. As shown in FIG. 6, a process of directly using the layout manner information, the dimension information of the view element, and the coordinate information of the view element by the apparatus for loading an application program view when loading the application program view may include the following steps.

S301. The apparatus for loading an application program view determines whether a version of an application program changes.

If the version of the application program does not change, S302 is executed; if the version of the application program changes, S303 is executed.

S302. The apparatus for loading an application program view determines whether a non-volatile storage medium stores a byte stream used to display an application program view.

S303. The apparatus for loading an application program view determines whether a non-volatile storage medium stores a byte stream of an application program of a new version.

The byte stream of the application program of the new version is a byte stream used to display an application program view of the new version, that is, a byte stream obtained after serialization processing is performed on layout manner information, dimension information, and coordinate information of the application program view of the new version.

S304. If the non-volatile storage medium stores the byte stream, a control apparatus for loading a view reads the saved byte stream from the non-volatile storage medium.

When the version of the application program does not change, the byte stream in this step is the byte stream described in S302. When the version of the application program changes, the byte stream in this step is the byte stream described in S303.

S305. The apparatus for loading an application program view performs deserialization processing on the read byte stream to obtain view information of the application program.

The deserialization is a process of restoring a binary sequence to an original object (for example, the view information in this embodiment of the present disclosure). Data is saved in a memory in a binary form, the byte stream is also saved in a binary form, and when the application program view is loaded, data needs to be read into the memory; therefore, time used to load the application program view according to the saved byte stream is shorter than that used to load the application program view according to a file in another format (for example, a text file and a table file).

The apparatus for loading an application program view may perform deserialization processing on the byte stream according to a byte stream format that is defined when the serialization processing is performed.

Specifically, the apparatus for loading an application program view may perform deserialization processing on the byte stream by using a serialization manager, to obtain the layout manner information, the dimension information, and the coordinate information. The serialization manager may be used to serialize and deserialize the byte stream.

S306. The apparatus for loading an application program view displays the application program view in a display interface according to the view information obtained by means of deserialization processing.

For a specific display method, reference may be made to a related method in the prior art, which is not described again in this embodiment of the present disclosure.

It should be noted that display of an application program view in the display interface by the electronic terminal is classified into vertical screen display (a short side of a display screen of the electronic terminal is in a horizontal direction, and a long side of the display screen of the electronic terminal is in a vertical direction) and horizontal screen display (the long side of the display screen of the electronic terminal is in the horizontal direction, and the short side of the display screen of the electronic terminal is in the vertical direction).

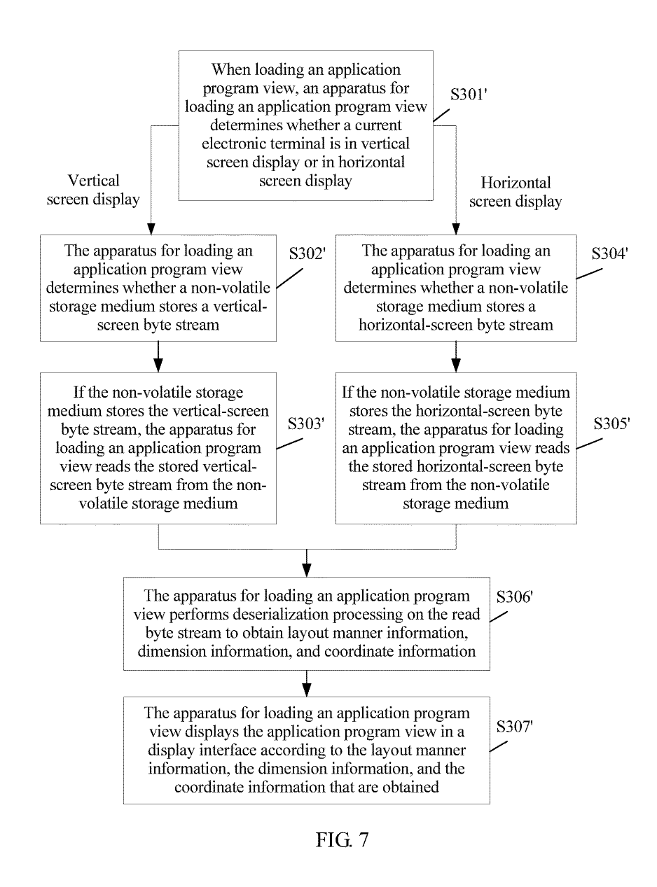

Further, in this embodiment of the present disclosure, layout manner information, dimension information, and coordinate information in the vertical screen display and the horizontal screen display may be separately saved as byte streams, that is, a vertical-screen byte stream (corresponding to the vertical screen display) and a horizontal-screen byte stream (corresponding to the horizontal screen display). As shown in FIG. 7, a process of directly using the layout manner information, the dimension information, and the coordinate information by the control apparatus for loading a view when loading the application program view may include the following steps:

S301′. When loading an application program view, the apparatus for loading an application program view determines whether a current electronic terminal is in vertical screen display or in horizontal screen display.

If the current electronic terminal is in the vertical screen display, S302′ to S303′ are executed; if the current electronic terminal is in the horizontal screen display, S304′ to S305′ are executed.

S302′. The apparatus for loading an application program view determines whether a non-volatile storage medium stores a vertical-screen byte stream.

S303′. If the non-volatile storage medium stores the vertical-screen byte stream, the apparatus for loading an application program view reads the saved vertical-screen byte stream from the non-volatile storage medium.

S304′. The apparatus for loading an application program view determines whether a non-volatile storage medium stores a horizontal-screen byte stream.

S305′. If the non-volatile storage medium stores the horizontal-screen byte stream, the apparatus for loading an application program view reads the saved horizontal-screen byte stream from the non-volatile storage medium.

It should be noted that regardless of whether the current electronic terminal is in the vertical screen display or in the horizontal screen display, after the byte stream is read, deserialization processing needs to be performed on the read byte stream, to obtain view information used to display the application program view. That is, after S302′ to S303′ or S304′ to S305′ are executed, S306′ to S307′ may continue to be executed.

S306′. The apparatus for loading an application program view performs deserialization processing on the read byte stream to obtain layout manner information, dimension information, and coordinate information.

S307′. The apparatus for loading an application program view displays the application program view in a display interface according to the layout manner information, the dimension information, and the coordinate information that are obtained.

According to the method for loading an application program view provided in this embodiment of the present disclosure, after view information used to load an application program view is obtained, serialization processing can be performed on the view information to obtain a byte stream used to display the application program view; and the byte stream is saved in a non-volatile storage medium. The non-volatile storage medium of an electronic terminal stores the byte stream used to display the application program view; therefore, the electronic terminal does not need to parse a layout file and calculate dimension information and coordinate information of a view element each time of loading the application program view, but can directly load the application program according to the byte stream that is saved in the non-volatile storage medium and used to display the application program view, which can reduce time used to load the application program view. Because the time used to load the application program view is shortened, startup efficiency of the application program is improved, and user experience can be improved.

### Embodiment 3

This embodiment of the present disclosure provides an apparatus 40 for loading an application program view, where the apparatus 40 for loading an application program view may be configured to execute the methods in FIG. 1, FIG. 3A and FIG. 3B, FIG. 6, and FIG. 7. For a description of a related functional module, the descriptions in the foregoing method embodiments may be cited.

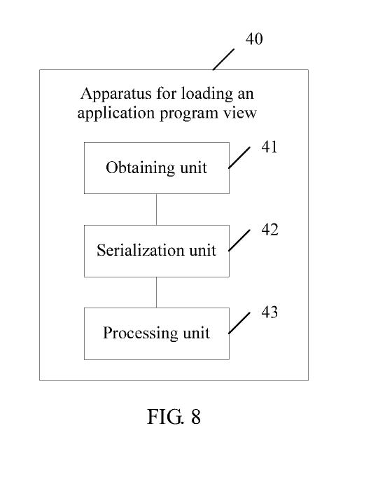

Specifically, as shown in FIG. 8, the apparatus 40 for loading an application program view may include a obtaining unit 41, a serialization unit 42, and a processing unit 43.

The obtaining unit 41 is configured to obtain view information of an application program, where the view information includes layout manner information of a view element, in a display interface, of an application program view, dimension information of the view element, and coordinate information of the view element in the display interface.

The serialization unit 42 is configured to perform serialization processing on the view information obtained by the obtaining unit 41, to obtain a byte stream used to display the application program view.

The processing unit 43 is configured to save, in a non-volatile storage medium, the byte stream obtained by the serialization unit 42, so as to load the application program view according to the saved byte stream when the application program view is reloaded.

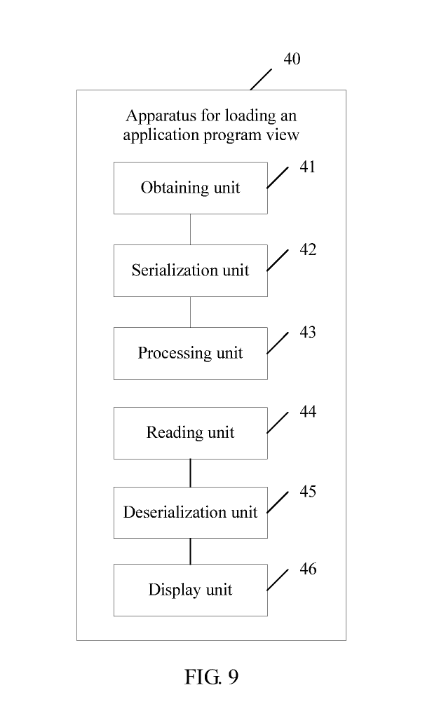

Further, as shown in FIG. 9, the apparatus 40 for loading an application program view may further include a reading unit 44, a deserialization unit 45, and a display unit 46.

The reading unit 44 is configured to, when the application program view is loaded, if it is determined that the non-volatile storage medium stores the byte stream used to display the view, read the byte stream from the non-volatile storage medium.

The deserialization unit 45 is configured to perform deserialization processing on the byte stream read by the reading unit 44, to obtain the view information.

The display unit 46 is configured to display the application program view in the display interface according to the view information obtained by the deserialization unit 45.

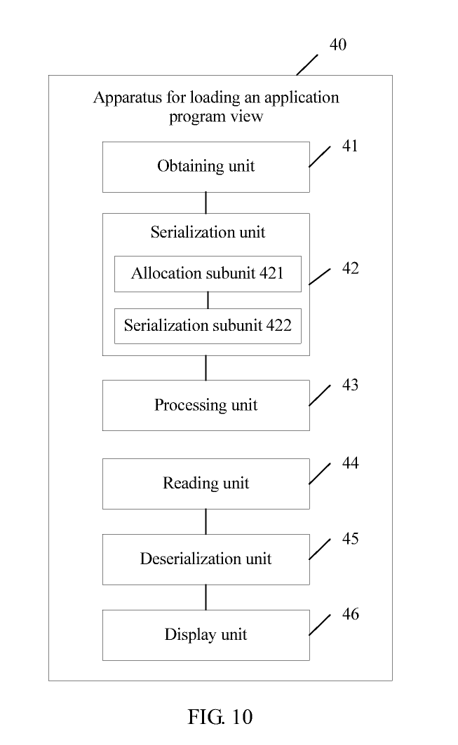

Further, as shown in FIG. 10, the serialization unit 42 includes an allocation subunit 421 and a serialization subunit 422.

The allocation subunit 421 is configured to allocate an identifier to the view element, and record a correspondence between the view element and the identifier of the view element.

The serialization subunit 422 is configured to perform serialization processing on the layout manner information of the view element in the display interface, the dimension information of the view element, and the coordinate information of the view element in the display interface according to the identifier allocated by the allocation subunit 421 to the view element, to obtain the byte stream used to display the application program view.

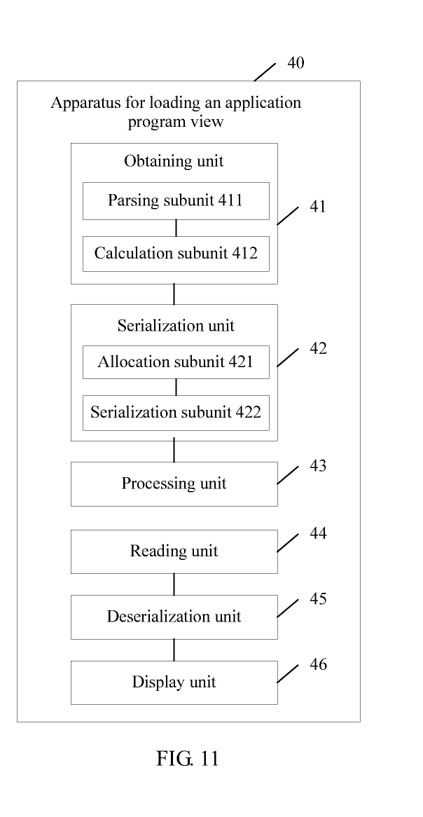

Further, as shown in FIG. 11, the obtaining unit 41 includes a parsing subunit 411 and a calculation subunit 412.

The parsing subunit 411 is configured to parse a layout file in an installation package of the application program to obtain the layout manner information of the view element in the display interface.

The calculation subunit 412 is configured to obtain, by means of calculation, the dimension information of the view element and the coordinate information of the view element in the display interface according to the layout manner information obtained by the parsing subunit 411 by means of parsing.

Further, the processing unit 43 is specifically configured to save, in a predefined file, the byte stream obtained by the serialization unit 42, where the predefined file includes a data file of the application program, and the data file of the application program is saved in the non-volatile storage medium and is used to store data information to be invoked by the application program.

It should be noted that, for specific descriptions of some functional modules in the apparatus for loading an application program view provided in this embodiment of the present disclosure, reference may be made to corresponding content in the method embodiments, and details are not described again in this embodiment.

According to the apparatus for loading an application program view provided in this embodiment of the present disclosure, after view information used to load an application program view is obtained, serialization processing can be performed on the view information to obtain a byte stream used to display the application program view; and the byte stream is saved in a non-volatile storage medium. The non-volatile storage medium of an electronic terminal stores the byte stream used to display the application program view; therefore, the electronic terminal does not need to parse a layout file and calculate dimension information and coordinate information of a view element each time of loading the application program view, but can directly load the application program according to the byte stream that is saved in the non-volatile storage medium and used to display the application program view, which can reduce time used to load the application program view. Because the time used to load the application program view is shortened, startup efficiency of the application program is improved, and user experience can be improved.

### Embodiment 4

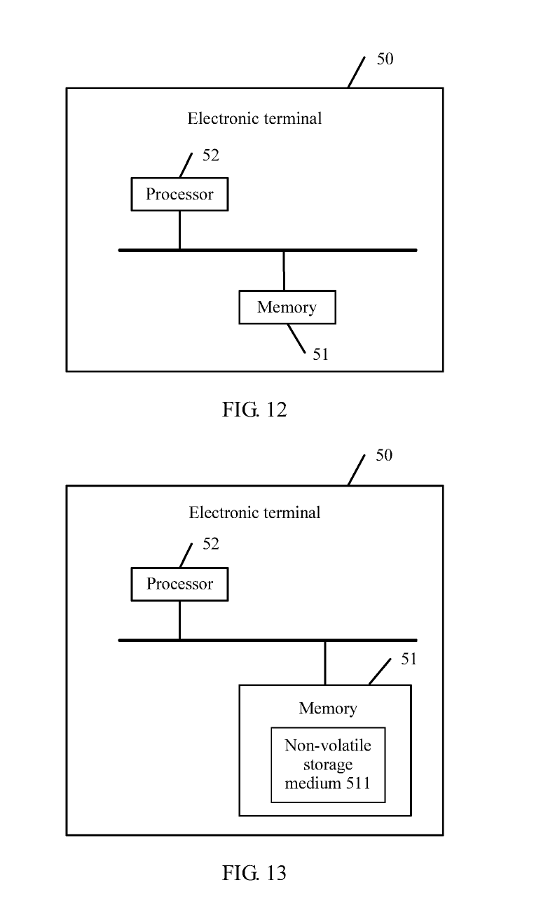

This embodiment of the present disclosure provides an electronic terminal 50. As shown in FIG. 12, the electronic terminal 50 includes a memory 51 and a processor 52, where the memory 51 is connected to the processor 52.

The memory 51 is configured to store a group of program code, where the memory is a computer storage medium of the electronic terminal, and as shown in FIG. 13, the computer storage medium includes a non-volatile storage medium 511. The program code saved in the memory 51 may be program code that has been set in the electronic terminal at delivery of the electronic terminal, or may be program code that has not been saved at delivery of the electronic terminal but is saved by installing an application program in the memory 51 by a user in a use process of the user. It should be understood that both the two situations shall fall within the protection scope of this embodiment of the present disclosure.

The processor 52 is configured to execute the program code saved in the memory 51 and is specifically configured to perform the following operations: obtaining view information of an application program, where the view information includes layout manner information of a view element, in a display interface, of an application program view, dimension information of the view element, and coordinate information of the view element in the display interface; performing serialization processing on the view information to obtain a byte stream used to display the application program view; and saving the byte stream in the non-volatile storage medium, so as to load the application program view according to the saved byte stream when the application program view is reloaded.

The non-volatile storage medium 511 is configured to store the byte stream that is obtained by the processor 52 by means of serialization processing and used to display the application program view.

The memory 51 and the processor 52 are connected and communicate with each other by using a bus.

The bus may be an Industry Standard Architecture (ISA) bus, a Peripheral Component Interconnect (PCI) bus, an Extended Industry Standard Architecture (EISA) bus, or the like. The bus may be classified into an address bus, a data bus, a control bus, and the like. For ease of denotation, the bus is represented by using one thick line in FIG. 9; however, it does not indicate that there is only one bus or only one type of bus.

The memory 51 is configured to store the program code, the application program, and all functional modules in the apparatus 50 for loading an application program view. The processor 52 runs the application program and the modules saved in the memory 51 to execute various functional applications of the apparatus 50 for loading an application program view and implement data processing. The memory 51 mainly includes a program storage area and a data storage area, where the program storage area may store an operating system, and an application program required by at least one function, for example, a voice play program and an image play program; and the data storage area may store data (for example, audio data) created according to use of the apparatus 50 for loading an application program view, and the like.

In a specific implementation manner of the present disclosure, the memory 51 may include the non-volatile memory 511, for example, at least one non-volatile storage medium storage component (for example, an EMMC), an electrically erasable programmable read-only memory (EEPROM), and a flash memory component, for example, a NOR flash memory or a NAND flash memory. The non-volatile memory stores the operating system and the application program executed by the processor 52. The processor 52 loads a running program and data from the non-volatile memory into a memory and saves data content in a large-capacity storage apparatus. The operating system includes a task used to control and manage a conventional system, for example, memory management, storage device control, and power management, and various components and/or drives facilitating communication between various software and hardware. In this implementation manner of the present disclosure, the operating system may be an Android system.

It should be noted that, in this embodiment of the present disclosure, the processor 52 may be a control center of the apparatus 50 for loading an application program view, for example, a central processing unit (CPU), where the control center may use various interfaces and lines to connect all parts of the whole apparatus 50 for loading an application program view, and run or execute the program code and/or the modules saved in the memory 51 and invoke the data saved in the memory 51, to execute various functions and/or process data of the apparatus 50 for loading an application program view. The processor 52 may include an integrated circuit (IC) or an application-specific integrated circuit (ASIC) (for example, the processor 52 may include a singly-encapsulated IC), or may include multiple connected encapsulated ICs with a same function or different functions. For example, the processor 52 may include only a CPU, or may be a combination of a CPU, a graphic processing unit (GPU), a digital signal processor (DSP), and a control chip in a communication unit (for example, a baseband chip). In an implementation manner of the present disclosure, the CPU may be a single-operation core, or may include a multi-operation core.

Further, the processor 52 is further configured to, when the application program view is loaded, when the application program view is loaded, if it is determined that the non-volatile storage medium stores the byte stream used to display the view, read the byte stream from the non-volatile storage medium; perform deserialization processing on the byte stream to obtain the view information; and display the application program view in the display interface according to the view information.

Further, the processor 52 is further configured to allocate an identifier to the view element, and record a correspondence between the view element and the identifier of the view element; and perform serialization processing on the layout manner information of the view element in the display interface, the dimension information of the view element, and the coordinate information of the view element in the display interface according to the identifier allocated to the view element, to obtain the byte stream used to display the application program view.

Further, the processor 52 is further configured to parse a layout file in an installation package of the application program to obtain the layout manner information of the view element in the display interface; and obtain, by means of calculation, the dimension information of the view element and the coordinate information of the view element in the display interface according to the layout manner information.

The memory 51 is further configured to store the predefined file.

Further, the processor 52 is further configured to save the byte stream in the predefined file, where the predefined file includes a data file of the application program, and the data file of the application program is used to store data information to be invoked by the application program.

The non-volatile storage medium 511 is further configured to store the data file of the application program.

It should be noted that, for specific descriptions of some functional modules in the apparatus for loading an application program view provided in this embodiment of the present disclosure, reference may be made to corresponding content in the method embodiments, and details are not described again in this embodiment.

According to the electronic terminal provided in this embodiment of the present disclosure, after view information used to load an application program view is obtained, serialization processing can be performed on the view information to obtain a byte stream used to display the application program view; and the byte stream is saved in a non-volatile storage medium. The non-volatile storage medium of the electronic terminal stores the byte stream used to display the application program view; therefore, the electronic terminal does not need to parse a layout file and calculate dimension information and coordinate information of a view element each time of loading the application program view, but can directly load the application program according to the byte stream that is saved in the non-volatile storage medium and used to display the application program view, which can reduce time used to load the application program view. Because the time used to load the application program view is shortened, startup efficiency of the application program is improved, and user experience can be improved.

The foregoing descriptions about implementation manners allow a person skilled in the art to understand that, for the purpose of convenient and brief description, division of the foregoing function modules is taken as an example for illustration. In actual application, the foregoing functions can be allocated to different modules and implemented according to a requirement, that is, an inner structure of an apparatus is divided into different function modules to implement all or part of the functions described above. For a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be saved in a computer-readable storage medium. Based on such an understanding, the technical solutions of the present disclosure essentially, or the part contributing to the prior art, or all or a part of the technical solutions may be implemented in the form of a software product. The software product is saved in a storage medium and includes several instructions for instructing a computer device (which may be a personal computer, a server, or a network device) or a processor to perform all or a part of the steps of the methods described in the embodiments of the present disclosure. The foregoing storage medium includes any medium that can store program code, such as a Universal Serial Bus (USB) flash drive, a removable hard disk, a read-only memory (ROM), a random access memory (RAM), a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1-16. (canceled)

17. A method for loading an application program view, comprising:
obtaining view information of an application program, wherein the view information comprises layout manner information of a view element in a display interface of an application program view, dimension information of the view element, and coordinate information of the view element in the display interface;
performing serialization processing on the view information to obtain a byte stream used to display the application program view; and
saving the byte stream in a non-volatile storage medium, so as to load the application program view according to the saved byte stream when the application program view is reloaded.

18. The method according to claim 17, further comprising:
reading the byte stream from the non-volatile storage medium;
performing deserialization processing on the byte stream to obtain the view information; and
displaying the application program view in the display interface according to the view information.

19. The method according to claim 17, wherein performing serialization processing comprises:
allocating an identifier to the view element;
recording a correspondence between the view element and the identifier of the view element; and
performing serialization processing on the layout manner information of the view element in the display interface, the dimension information of the view element, and the coordinate information of the view element in the display interface according to the identifier allocated to the view element, to obtain the byte stream used to display the application program view.

20. The method according to claim 17, wherein obtaining view information comprises:
parsing a layout file in an installation package of the application program to obtain the layout manner information of the view element in the display interface; and
calculating the dimension information of the view element and the coordinate information of the view element in the display interface according to the layout manner information.

21. The method according to claim 17, wherein saving the byte stream comprises saving the byte stream in a predefined file, wherein the predefined file comprises a data file of the application program, and the data file of the application program is saved in the non-volatile storage medium and is used to store data information to be invoked by the application program.

22. An apparatus for loading an application program view, comprising:
a nonvolatile storage medium; and
a processor coupled with the nonvolatile storage medium, wherein the processor is configured to:
obtain view information of an application program, wherein the view information comprises layout manner information of a view element in a display interface of an application program view, dimension information of the view element, and coordinate information of the view element in the display interface;
perform serialization processing on the view information to obtain a byte stream used to display the application program view; and
save the byte stream in the non-volatile storage medium, so as to load the application program view according to the saved byte stream when the application program view is reloaded.

23. The apparatus according to claim 22, wherein the processor is further configured to:
read the byte stream from the non-volatile storage medium;
perform deserialization processing on the byte stream to obtain the view information; and
display the application program view in the display interface according to the view information.

24. The apparatus according to claim 22, wherein the processor is further configured to:
allocate an identifier to the view element;
record a correspondence between the view element and the identifier of the view element; and
perform serialization processing on the layout manner information of the view element in the display interface, the dimension information of the view element, and the coordinate information of the view element in the display interface according to the identifier allocated by the allocation subunit to the view element, to obtain the byte stream used to display the application program view.

25. The apparatus according to claim 22, wherein the processor is further configured to:
parse a layout file in an installation package of the application program to obtain the layout manner information of the view element in the display interface; and
calculate the dimension information of the view element and the coordinate information of the view element in the display interface according to the layout manner information.

26. The apparatus according to claim 22, wherein the processor is further configured to save the byte stream in a predefined file, wherein the predefined file comprises a data file of the application program, and wherein the data file of the application program is saved in the non-volatile storage medium and is used to store data information to he invoked by the application program.

27. An electronic terminal, comprising:
a memory; and
a processor coupled with the memory,
wherein the memory is configured to store a group of program code, wherein the memory is a computer storage medium of the electronic terminal, and wherein the computer storage medium comprises a non-volatile storage medium,
wherein the processor is configured to:
execute the program code saved in the memory;
obtain view information of an application program, wherein the view information comprises layout manner information of a view element, in a display interface, of an application program view, dimension information of the view element, and coordinate information of the view element in the display interface; perform serialization processing on the view information to obtain a byte stream used to display the application program view; and
save the byte stream in the non-volatile storage medium, so as to load the application program view according to the saved byte stream when the application program view is reloaded, and
wherein the non-volatile storage medium is configured to store the byte stream that is obtained by the processor by means of serialization processing and used to display the application program view.

28. The electronic terminal according to claim 27, wherein the processor is further configured to:
read the byte stream from the non-volatile storage medium;
perform deserialization processing on the byte stream to obtain the view information; and
display the application program view in the display interface according to the view information.

29. The electronic terminal according to claim 27, wherein the processor is further configured to:
allocate an identifier to the view element;
record a correspondence between the view element and the identifier of the view element; and
perform serialization processing on the layout manner information of the view element in the display interface, the dimension information of the view element, and the coordinate information of the view element in the display interface according to the identifier allocated to the view element, to obtain the byte stream used to display the application program view.

30. The electronic terminal according to claim 27, wherein the processor is further configured to:
parse a layout file in an installation package of the application program to obtain the layout manner information of the view element in the display interface; and
calculate the dimension information of the view element and the coordinate information of the view element in the display interface according to the layout manner information.

31. The electronic terminal according to claim 27, wherein the processor is further configured to save the byte stream in a predefined file, wherein the predefined file comprises a data file of the application program, wherein the data file of the application program is used to store data information to be invoked by the application program, and wherein the non-volatile storage medium is further configured to store the data file of the application program.
